(19) United States
(12) Patent Application Publication
(10) Pub. No.: US 2007/0186015 A1
(43) Pub. Date: Aug. 9, 2007

(54) Custom edid content generation system and method

(76) Inventors: Frederick D. Taft, Corvallis, OR (US); Michael S. Setera, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/351,007

(22) Filed: Feb. 8, 2006

(51) Int. Cl. G06F 3/00

(52) U.S. Cl. 710/16

(57) ABSTRACT

A composite EDID content generator includes an EDID memory module, containing EDID information, and a processor, interconnected to the EDID memory module and interconnected between an AV source device and a plurality of AV sink devices. Each AV sink device has a unique EDID, and the processor is configured to generate a combined EDID representing the combined characteristics of the plurality of AV sink devices, and to transmit the combined EDID to the AV source device.

### BACKGROUND

In contemporary audio-visual (AV) systems, AV devices frequently use an EDID (Extended Display Identification Data) to expose information about the devices' capabilities. As more complex devices (i.e. switch boxes) are developed for allowing easy routing of audio and video signals to one or more sink devices (i.e. projectors, TVs, 5.1 surround sound systems, etc), the problem of making sure the correct EDID information is exposed to the source devices becomes more critical.

A source device typically uses the EDID information, exported by a sink device, in order to determine the capabilities of the sink device and in order to send optimal data to the sink device. In the simple environment where both the audio and video information is directed from a single source device to a single sink device, it is adequate for the source device to directly access the sink device's EDID.

However, in a more complex environment where either the audio or video sink devices are not the same physical device, then it does not work to simply expose the video sink device's EDID, because it does not correctly describe the composite device made up of the combination of the audio and video sink devices.

Some known switch boxes have the ability to ‘mirror’ the EDID information associated with one of the sink devices, but they do not allow the switch box to construct EDID content which correctly describes a composite sink device (e.g. one in which video is directed to one device while the audio is directed to a completely separate device). For example, so-called DVI distribution amplifier devices, which allow a DVI source device to broadcast to a number of DVI sink devices, are commercially available. With such devices a user can select which of the DVI sink devices will have its EDID exposed to the source device. However, with such known devices there is no modification to the EDID content by the DVI distribution amplifier device. Some of these devices can read and cache the EDID content (so that they are available to the source device even when the sink device is off), but that does not solve the problem of producing EDID content which correctly describes a composite sink device.

### BRIEF DESCRIPTION OF THE DRAWINGS

Various features and advantages of the invention will be apparent from the detailed description which follows, taken in conjunction with the accompanying drawings, which together illustrate, by way of example, features of the invention, and wherein:

FIG. 1 is a block diagram of an embodiment wherein source and sink devices both use the same transmission format, and audio and video signals are routed to a single sink device;

FIG. 2 is a block diagram of an embodiment wherein source and sink devices both use the same transmission format, but the video signal is routed to an HDMI sink device while the audio signal is routed to a 5.1 audio device;

FIG. 3 is a block diagram of an embodiment wherein the source and sink devices use different transmission formats, and the video signal is routed to a DVI sink device, while the audio signal is routed to a 2-channel audio device;

FIG. 4 is a block diagram of an embodiment wherein the source device provides VGA video output, while audio output is provided by a separate audio source device, and the audio and video are both routed to a single HDMI sink device;

FIG. 5 is a block diagram of an embodiment of a switch box configured for custom EDID content generation; and

FIG. 6 is a flow chart showing one embodiment of the steps involved in controlling the custom EDID content generation system.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

As noted above, there are many classes of sink devices (projectors, TVs, computer monitors, etc), which use an EDID (Extended Display Identification Data) to expose information about the sink device's capabilities. The EDID content can include information about both the video and audio capabilities of the sink device. Typically the source device (the device sending data to the sink device) reads the sink device's EDID, and then uses this information to determine the optimal format to use when sending the data to the sink device.

In a composite sink device where, for example, an audio sink device and video sink device are connected to a common source but are not the same physical device, it does not work simply to expose the video sink device's EDID to the source device because the video sink device's EDID may not correctly describe the composite device made up of the combination of the audio and video sink devices. Some known switch boxes have the ability to ‘mirror’ the EDID information associated with one of the sink devices, but they do not allow the switch box to dynamically construct EDID content which correctly describes a composite sink device (e.g. one in which video is directed to one device while the audio is directed to a completely separate device).

This disclosure describes a system and method which can be used to dynamically construct custom EDID content based on a combined feature set supported by both audio and video sink devices. The system and method provides a solution for dynamically defining EDID information, so that the EDID information correctly describes the full capabilities of a composite sink device.

Certain classes of devices, such as a switch box, can be placed between the sink device and the source device. The switch box can be used to direct data from the source device to one or more sink devices. The switch box may direct all of the source data (audio and video) to a single sink device, or it may direct the audio and video components to different sink devices (i.e. video to a projector and audio to a 5.1 surround sound system). In this latter case, the switch box is faced with the problem of how to correctly describe the characteristics of the composite sink device, using the EDID information. Simply exposing the video sink device's EDID information may result in the source device sending the audio data in a non-optimal format (since the audio sink device is different from the video sink device, and thus, is not described by the video sink device's EDID).

The inventors have devised a smart switch box that has the ability to dynamically define the EDID content presented to the source device. The dynamic EDID content can then be tuned to correctly describe the composite sink device. A secondary aspect of the system and method is to allow the switch box to dynamically update the EDID content, should the user select a different audio or video sink device (i.e. the user switches from a 5.1 surround sound audio system to a L/R stereo audio system).

In some cases, the switch box can be configured simply to allow direct access to the sink device's EDID, if the sink device's EDID is deemed to accurately reflect the characteristics of the sink device (e.g. both the audio and video are directed to the same HDMI sink device).

As used herein, the following terms will have the following meanings.

The term “Source” refers to the device sending (or generating) audio and video input. “Sink” refers to the device receiving video (and possibly audio) data.

The abbreviation “DDC” stands for Display Data Channel, and refers to an 12C-based protocol, typically used by source devices to read the contents of a sink device's EDID, and used during HDCP protocol exchanges.

The abbreviation “HDCP” stands for High-bandwidth Digital Content Protection, and defines a protocol for exchanging protected content between a source and a sink device. Its purpose is to prevent unauthorized copying of protected content. The sink and source devices use the DDC to initially validate that each device is in fact an authorized device before data is sent. Afterward, the two devices will periodically re-validate one another, to prevent someone from maliciously switching to a different, unauthorized sink device.

The abbreviation “HPD” stands for Hot Plug Detect, and refers to a control line between the sink and source device. The HPD line is available when using an HDMI or DVI connection, but is not available when using a VGA connection. When present, it is used by the sink device to indicate to the source device that the EDID is available for reading. Anytime this control line is low, the source device is not supposed to attempt to read the sink's EDID.

The abbreviation “E-EDID” stands for Enhanced Extended Display Identification Data. The base E-EDID structure is defined by the VESA standards organization. The base E-EDID structure is defined to be a 128-byte block of data, describing capabilities of the sink device. The base structure allows for the inclusion of 0-n EDID extensions, which can be used to further define the capabilities of the sink device. A source device can read the contents of a sink device's EDID using the DDC control lines. Typically, a sink device will indicate that its EDID information is available for reading, using the HPD control line.

An “EDID Extension” is one or more 128-byte extensions, in addition to the basic 128-byte base EDID information, which a sink device can optionally define, and which can be used to expose additional characteristics of the sink device. At the present time, there are at least two independent EDID extension definitions: CEA-861-B (published by the Consumer Electronics Association) and DI-EXT (published by VESA). It is believed that some source devices only work when a particular EDID extension is present.

The abbreviation “TMDS” stands for Transition Minimized Differential Signaling. This refers to a channel used to transmit video content (HDMI and DVI) and embedded audio content (HDMI-only).

The abbreviation “HDMI” stands for High-Definition Multimedia Interface. This standard defines the means for a source device to transmit both protected and unprotected audio and video information to a sink device. Protected content is transmitted using the HDCP protocol, which prevents the protected material from unauthorized copying. HDMI uses TMDS to send audio and video data.

The abbreviation “DVI” stands for Digital Visual Interface. This standard defines the means for a source device to transmit both protected and unprotected video information to a sink device. Protected content is transmitted using the HDCP protocol, which prevents the protected material from unauthorized copying. DVI uses TMDS to send video data only.

The system and method disclosed herein allows one to dynamically create EDID information, so that it accurately describes the capabilities of a composite sink device, and allows optimal signals to be sent to each sink device. Conversely, the system can also generate custom EDID content to allow input signals from multiple source devices to be combined and output to one or more sink devices. In one embodiment, the system comprises a “smart” switch box that is placed between the source device(s) and the sink device(s) and directs data from the source device(s) to the sink device(s). When the switch box directs the audio and video components to different sink devices, it dynamically defines the EDID content so as to correctly describe the composite sink device. The system and method allows for the detection of different EDID information for different sink devices, and the dynamic construction of new EDID information to accurately describe a composite sink device.

The following discussion will illustrate various embodiments of a dynamic EDID content generation system and method to facilitate the connecting of various audio/video source device(s) to various audio/video sink device(s). For these examples, a smart switchbox is depicted as the device implementing the dynamic EDID concept, though this is only one example of an implementation of the system. For example, the functions of the smart switchbox can be integrated into an AV source or sink device, such as a large screen television, digital projection system, surround sound system, etc.

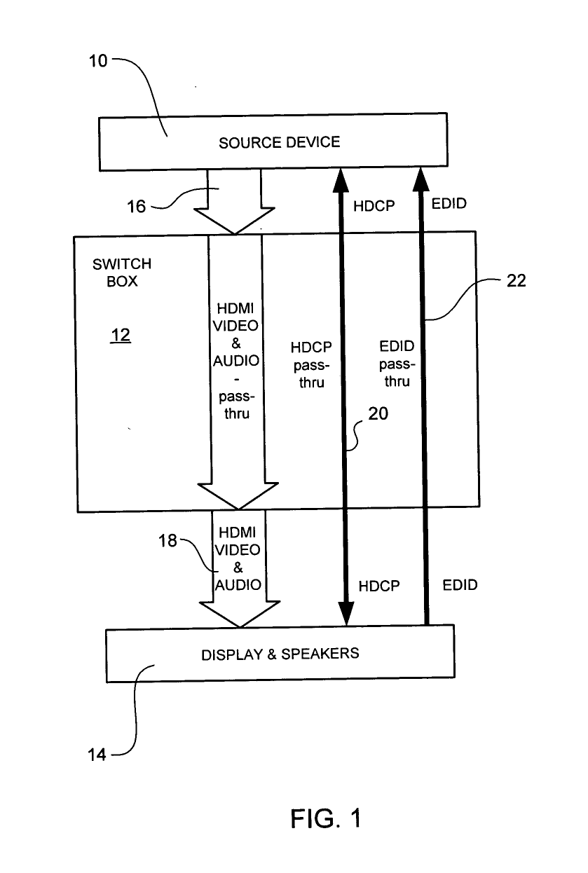

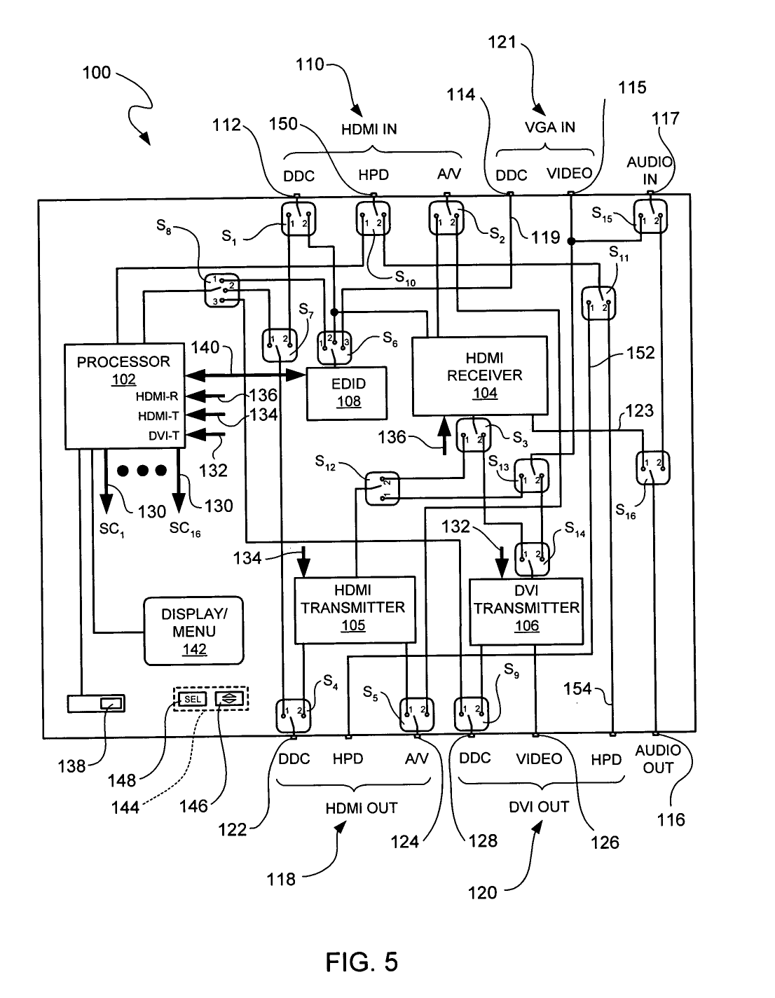

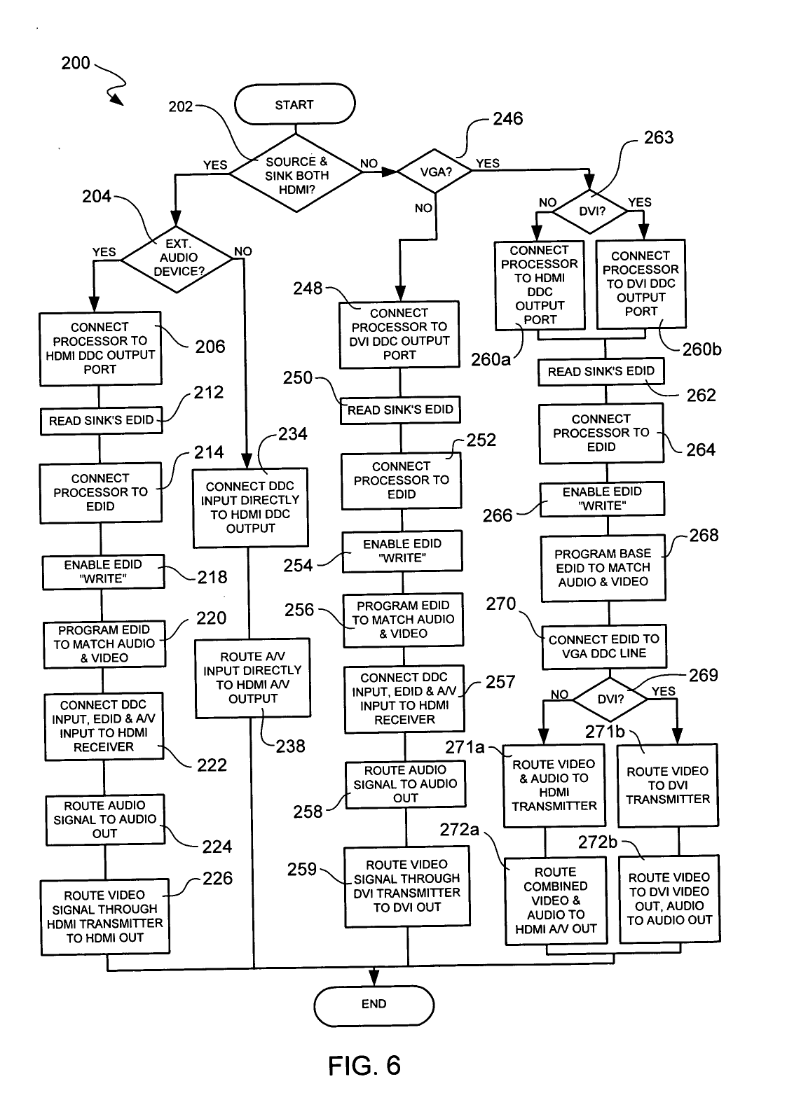

Shown in FIGS. 1-4 are block diagrams of four exemplary situations in which audio and video signals are routed from one or more source devices, through a smart switchbox, to one or more sink devices. In FIG. 1 the source device is indicated generally at 10, the smart switchbox is indicated generally at 12, and the sink device is indicated generally at 14. The steps executed by the system for each of the situations shown in FIGS. 1-4 are diagrammed in the flow chart 200 in FIG. 6. The switchbox 12 shown in FIGS. 1-4 can be a single device that has the functionality required for the situations of each of the figures, though only certain aspects of its operation are utilized in each example. In other words, the switchbox embodiment shown in FIG. 5 can accommodate the situations in each of FIGS. 1 through 4.

Referring to FIG. 1, the smart switchbox 12 is configured to determine when it needs to expose a custom EDID to the source device and when it can simply allow the EDID of the sink device to be directly accessed by the source device. For this reason the switchbox is configured to decode the incoming audio/video signal, indicated generally at 16 in FIG. 1, sent by the source device 10, in order to split the audio and video data, such as where the audio and video sink devices are not the same device, for example. This may require that the switchbox then re-encode the video signal for transmission to the video sink device. In that case, the switchbox may be required to support HDCP on both the receiving end (from the source device) and the sending end (to the sink device), in order to properly deal with protected data.

Ordinarily, the switchbox 12 will completely isolate the source 10 and sink devices 14 onto separate DDC buses. This is because HDCP authentication is done using the DDC lines, and there is a need to keep authentication between the source device and the switchbox separate from the authentication between the sink device and the switchbox. Either all DDC communications are passed through (if a custom EDID is not in use), or the lines are isolated when a custom EDID is in use. When DDC communications are passed through, the DDC lines of the sink are connected directly to the DDC lines of the source, as described in more detail below.

Shown in FIG. 5 is one embodiment of a smart switchbox 100 that can accommodate the situations shown in FIGS. 1-4. This switchbox includes a microprocessor 102, an HDMI receiver 104, an HDMI transmitter 105, and a DVI transmitter 106. Also included is an embedded EDID block 108, which can be a block of electronically eraseable programmable read-only memory (EEPROM) that is configured to store EDID information. The switchbox includes an HDMI input port 110 for connecting to a source device. The HDMI input port includes a DDC input line 112 and an AN input line 114. It should be noted that the various “lines” shown in FIG. 5, such as the AN lines, DDC lines, and HPD lines, represent lines of communication and transmission, and do not necessarily represent a single conductor or single transmission line. Instead, these lines can represent multiple conductors for carrying both audio and video signals, etc., as may be required. The switchbox also includes a VGA input port 121, which includes a VGA input line 115 for receiving VGA signals, and a DDC line 119. An external audio input line 117 is also provided for receiving audio from an external audio device. The switchbox also includes a plurality of output locations, including an audio output line 116, an HDMI output port 118, and a DVI output port 120. The HDMI output port includes a DDC output line 122 and an A/V output line 124. The DVI output port includes a DVI video output line 126 and a DDC output line 128.

The switchbox 100 also includes several Hot Plug Detect (HPD) lines. The HDMI input port 110 includes an HPD input line 150, and the HDMI output port 118 includes an HPD output line 152. Another HPD output line 154 is also provided as part of the DVI output port 120. The HPD input and output lines are part of the respective HDMI or DVI connectors. The HPD input line connects through switch S10 to the processor 102 and to switch S11. At switch S11 the HPD line diverges to one of the two HPD output lines 152 and 154. The HPD lines allow the exchange of the HPD signals between the source and sink devices, with the switches being controlled to route the signals between the correct input and output ports, and the processor.

The processor 102, the EDID block 108, and the transmitters and receivers are interconnected to each other and to the various input and output lines by a series of switches, labeled S1 to S16. These switches are controlled by the processor through a series of switch control lines 130, labeled SC1 to SC16. The switch control lines are shown leaving the microprocessor, but are not shown extending to the switches simply to avoid additional complexity in the figure. The transmitters and receivers are interconnected to the processor via lines 132-136, which are also shown discontinuous for clarity. The EDID block is connected to the processor via control line 140. As FIG. 5 shows, the processor 102 has two paths to the EDID 108. The path through the control line 140 is used to enable or disable write-protection of the EDID data. The other path, via the DDC lines through switches S6 and S8, is for accessing the EDID data itself.

The switchbox 100 can also include an audio sink switch 138, which is configured to allow a user to select the audio output destination for the signals that are to be routed through the switchbox. This switch can be a mechanical switch or an embedded switch that is activated by the processor in response to input via a menu or other input mechanism. The switch can include multiple positions or settings, whether mechanical or otherwise, allowing a user to select from among multiple audio destination options.

The switchbox can also include a visual display 142, such as an LCD display, that allows a user to view a menu screen, a status screen, and/or other feedback displays. The switchbox can include input devices 144 associated with the visual display, for allowing the user to navigate through menus provided on the display and provide input. These input devices can include, for example, a scroll button 146 for scrolling through menu options, and a select button 148 for selecting or adjusting settings. The display and associated input devices are optional. The switchbox can be configured for input and control through other devices, or via control menus and displays associated with the source or sink device(s). It will also be apparent that other types of input devices, such as a serial interface, can also be associated with the switchbox for allowing input and control.

The switches S1-S16 are each two-position switches, except for switches S8 and S6, which are three-position switches. The positioning of the switches is controlled by the processor 102 to allow receipt of source signals, reading of EDID information, generation of custom EDID information, and providing that information to the source device, as explained in more detail below in connection with a series explanatory examples.

In perhaps the simplest implementation of the system and method, shown in FIG. 1, a user configures the switchbox 12 to reflect that the source device 10 is an HDMI device, and the sink device 14 is a single HDMI device having a display and speakers. This determination is made at step 202 in the flow chart of FIG. 6. With reference to the switchbox 100 of FIG. 5, this determination can be made via user input through the display 142 and input devices 144, or through other input means. Additionally, the switchbox itself can confirm the characteristics of the output by setting switch S4 to position 1, setting switch S7 to position 1, and switch S8 to position 2. This allows the processor to detect the characteristics of the attached sink device and confirm that it is an HDMI device.

An additional factor that the switchbox must consider is whether an external audio device is selected, this determination being represented at step 204 in FIG. 6. Like the video type detection step, this determination can be made via user input through the display 142 and input devices 144, shown in FIG. 5. Additionally, the position of the audio sink switch 138 can also indicate whether an external audio device is selected.

Referring back to FIG. 1, the source 10 and sink 14 devices are both using the same transmission medium (HDMI) in this situation, and thus both the audio and video signals are being routed via a single AN output signal, indicated generally at 18, to the same sink device 14. The steps in causing this signal routing are shown in the second column in the flow chart of FIG. 6. When the source and sink are both HDMI (step 202) and an external audio device is not selected (step 204), the next step is to route the DDC input directly to the HDMI DDC output line 122 (step 234). With reference to the switchbox embodiment of FIG. 5, this can be done by setting switch Si to position 1, setting switch S7 to position 2, and switch S4 to position 1. These steps allow the signal received in the DDC input line 112 to be routed directly to the DDC output line 122. The next step is to route the AN input directly to the HDMI AN output line 124 (step 238). In the switchbox of FIG. 5 this is done by setting switch S2 to position 2, and switch S5 to position 2 so that the signal received through the AN input line 114 is routed directly to the AN output line 124. The result is that the audio and video are both directed to the HDMI sink device.

With reference again to FIG. 1, the result of these steps is to cause the HDCP data signal, represented by line 20, and the sink device's EDID, represented by line 22, to simply pass through the switchbox without alteration or interception. This is possible because the sink device's EDID correctly describes the capabilities of the sink device. In the scenario of FIG. 1, the switchbox 12 disables the EDID block (108 in FIG. 5) within the switchbox, and allows direct access to the EDID in the sink device. This allows the source device to directly receive the EDID from the sink device. Likewise, the video and audio signals are passed directly through the switchbox to the sink device.

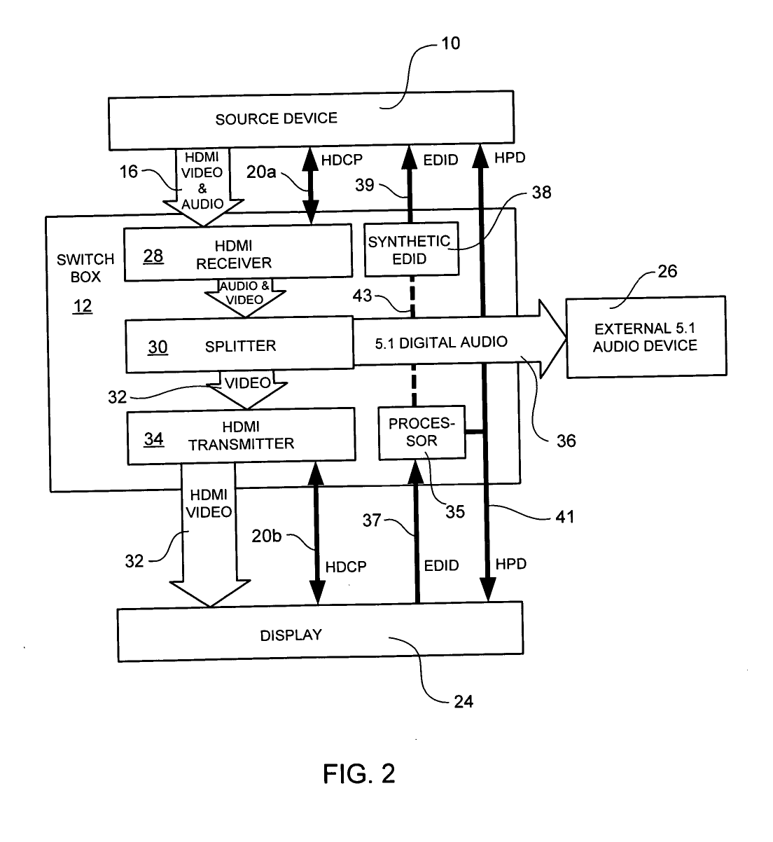

Another embodiment of the system and method is illustrated in FIG. 2, and the steps in the corresponding method are shown in the left column of FIG. 6. In this embodiment, a single ANV source device 10 is connected to multiple sink devices. Specifically, the switchbox 12 is configured to receive the input signal 16 from a single HDMI source device, while the sink device includes an HDMI display device 24 and an external 5.1 surround sound audio device 26, which together comprise a composite sink device.

In this situation, the source device and composite sink device are both using the same transmission medium (HDMI), but the audio and video signals are not both routed to the same sink device. Consequently, the switch box 12 cannot simply expose the video sink device's EDID to the source device because that EDID most likely does not correctly describe the capabilities of this composite sink device. Accordingly, the switchbox 12 includes an HDMI receiver 28 (104 in FIG. 5) that receives the input signal 16, and splits the input signal, routing the video output signal 32 through an HDMI transmitter 34 to the HDMI display device 24, while the audio output signal 36 is routed from the splitter 30 to the 5.1 audio device 26. The HDMI receiver 104 in FIG. 5 functions as both the receiver 28 and splitter 30 shown in FIG. 2, and separates the audio and video portions of a signal.

In order to allow this operation, the switchbox 12 is configured to create and present a custom or synthetic EDID 38 that accurately describes the video capabilities supported by the HDMI display device 24, and the audio capabilities of the 5.1 audio sub-system 26. This provides the source device 10 with the opportunity to send an audio output signal 36 that is optimized for the audio device.

In the configuration of FIG. 2, when dynamically updating the EDID contents, the processor 35 in the switchbox 12 reads the contents of the sink device's EDID, represented by line 37. At that point the processor creates a new custom EDID 38, which can involve reprogramming the base 128-byte custom base EDID, along with one or more 128-byte EDID extensions. The reprogramming of the EDID block 38 by the processor 35 is represented by dashed line 43. The system then enables access to the custom EDID by the source device 10, the transmission of the custom EDID being represented by arrow 39. Before reading the contents of the sink's EDID, the processor first disables the HPD line, to prevent the source device from attempting to access the EDID during reprogramming. In the configuration of FIG. 5, this can be done by moving switch S10 to position 1, causing the HPD line to be connected to the processor alone. This places the processor in control of traffic on the HPD lines, and is indicated by the branch in arrow 41. After creation of the custom EDID, the processor then re-enables the HPD line to allow on-going operation of the system.

Because the TMDS signal for HDMI can contain both audio and video information, it is necessary for the switchbox 12 to decode the TMDS signal, in order to extract the audio data. As noted above, this decoding and splitting function can be performed by the HDMI receiver. Specifically, the functions of the receiver 28 and splitter 30 of FIG. 2 can both be performed by the HDMI receiver 104 of FIG. 5. This allows the audio data to be re-directed to the audio device 26, while the video data is re-encoded into a TMDS signal, which can then be sent to the HDMI sink device 24.

It will also be noted that in FIG. 2 the HDCP line is broken into two parts, 20a and 20b. HDCP authentication occurs between each tramsmitter/receiver pair by way of the corresponding DDC lines. When the HDMI receiver 28 (104 in FIG. 5) in the switch box is used, it performs HDCP authentication with the source device 10, as represented by line 20a. When the HDMI transmitter 34 (105 in FIG. 5) is used, it independently performs HDCP authentication with the video sink device 24, as indicated by line 20b. Likewise, in the applications discussed below, HDCP authentication also takes place via the respective DDC line between the DVI transmitter (106 in FIG. 5) and an attached DVI sink device. Because these are independent operations, two separate HDCP lines 20 are shown in FIG. 2.

Viewing the left portion of the flow chart of FIG. 6, and referring to the structure of FIG. 5, in the configuration of FIG. 2 the user first provides input to the switchbox and/or the switchbox automatically detects the characteristics of the connected video sink device in the manner described above, indicating that the source and sink are both HDMI (step 202), but that an external audio device is selected (step 204). Consequently, the processor 102 first connects the processor to the HDMI DDC output line 122 (step 206) in order to read the sink's EDID (step 212). In the switchbox of FIG. 5, this is done by setting switch S8 to position 2, switch S7 to position 1, and switch S4 to position 1.

The system then connects the processor 102 to the EDID block 108 (step 214) and enables the system to write to the EDID block (step 218). This is done in order to allow the new synthetic EDID that is prepared by the processor to be sent to the EDID block. In the switchbox of FIG. 5, connection of the processor to the EDID block is done by setting switch S8 to position 1, and switch S6 to position 1. Enablement of the EDID write is effected through control line 140. The processor then writes the new EDID that correctly describes the composite sink to the EDID block (step 220).

With the new EDID in place, the processor then connects the DDC input line 112 and EDID block 108 to the HDMI receiver 104 (step 222), allowing the new EDID to be read by the source device, and providing a DDC connection between the receiver and the source to allow periodic HDCP authentication. This is done by setting switch S1 to position 2, and switch S6 to position 2. The processor also routes the HDMI AN input to the HDMI receiver 104 (still step 222) by setting switch S2 to position 1.

At this point the HDMI receiver 104 splits the audio and video signals and routes the audio signal through line 123 to the external audio line 116 (step 224). In the switchbox of FIG. 5, this requires setting switch S16 to position 1. The system then routes the video signal from the HDMI receiver to the HDMI transmitter 105, and thence to the HDMI OUT port 118 (step 226). This is done by setting switch S3 to position 1 and S12 to position 2, to route the receiver output signals to the HDMI transmitter, and by setting switch S5 to position 1 to provide the video output through the HDMI AN output line 124. The system also sets S4 to position 2 to provide a DDC connection between the HDMI transmitter and the sink device, to allow periodic HDCP authentication. This configuration allows the high quality separation of the audio and video signals as shown in FIG. 2.

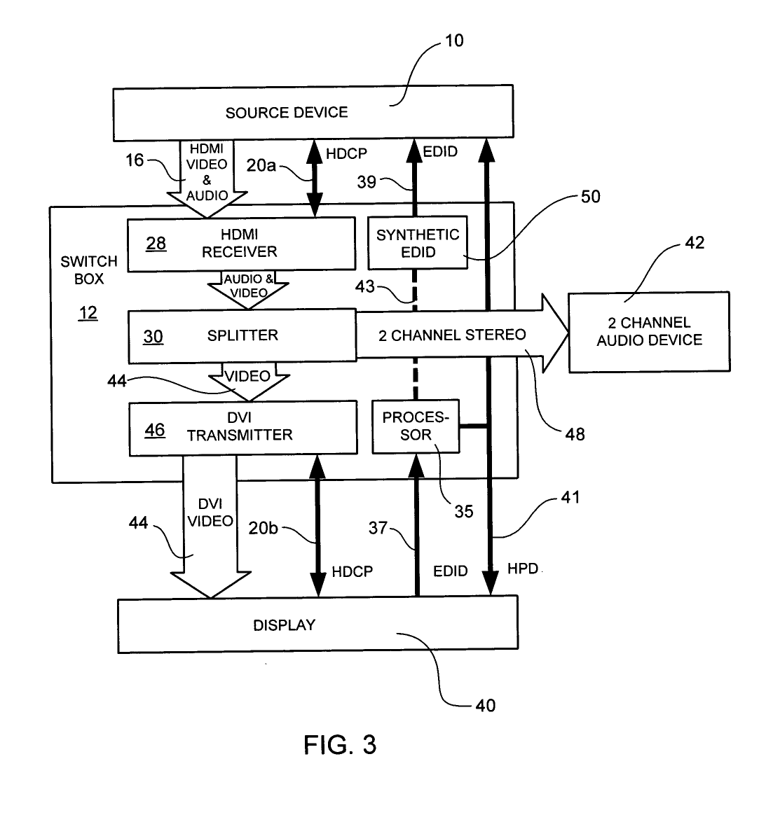

Another embodiment of the system and method is illustrated in FIG. 3, and the steps related to the associated method are shown in the third column of the flow chart of FIG. 6. With reference to FIG. 3, the switchbox 12 is configured to receive an input signal 16 from an HDMI source device 10, and route the signal to a composite sink device comprising a DVI display device 40 and a 2-channel (LUR) stereo audio device 42. In this configuration, the switchbox receives the AN input signal 16 via the HDMI receiver 28, and splits the signal into audio and video portions via the splitter 30. Again, the functions of the receiver 28 and splilter 30 of FIG. 3 can both be performed by the HDMI receiver 104 of FIG. 5. The DVI video output signal 44 is routed through a DVI transmitter 46 to the DVI display device 40, while the 2-channel stereo audio output signal 48 is routed to the 2 channel audio device 42.

In this situation it is necessary for the switchbox 12 to expose a custom EDID because the EDID of the DVI sink device 40 will not contain any information describing the audio device 42. Accordingly, the switchbox creates a custom EDID 50 that accurately describes the characteristics of the DVI display and the 2-channel audio device, and routes this custom EDID to the source device, as indicated at 39. The reprogramming of the EDID block 50 by the processor 35 is represented by dashed line 43. To do this, the switchbox can either expose a base EDID with a CEA EDID extension, or a base EDID with an EDID DI extension. As with the embodiment of FIG. 2, the HPD line 41 is controlled by the processor 35 so that it can be disabled during reprogramming of the EDID, and the HDCP lines 20a and 20b are broken to represent independent HDCP authentication between the source and receiver, and transmitter and sink, respectively.

Those skilled in the art will also recognize that even though the current DI EDID extension definition has reserved space for specifying audio capabilities, the contents of the reserved space are not defined. Thus, it can be desirable for the switchbox to expose a CEA EDID extension.

Viewing the flow chart of FIG. 6, with reference to the function of FIG. 3 and the structure of FIG. 5, the user first provides input to the switchbox and/or the switchbox automatically detects the characteristics of the connected video sink device in the manner described above, indicating that the source and sink are not both HDMI (step 202), and that the source is not VGA (step 246). Consequently, the system first connects the processor 102 to the DVI DDC output line 128 (step 248). This is done by setting switch S8 to position 3, and setting switch S9 to position 1. This connection allows the processor to read the sink's EDID (step 250). The processor then connects to the EDID block 108 (step 252) by setting switch S8 to position 1 and switch S6 to position 1. The processor then creates a new EDID correctly describing the composite sink, enables writing of the EDID (step 254), and writes this custom EDID to the EDID block 108 (step 256).

In order to allow the use of this new custom EDID, the processor then connects the DDC input line 112 and EDID to the HDMI receiver 104, and also routes the AN input from input line 114 to the HDMI receiver (step 257). This is done by setting switch S1 to position 2, S6 to position 2, and S2 to position 1. This allows the source device to access the new custom EDID, and also allows the HDMI receiver 104 to be connected to the DDC input line 112 to allow periodic HDCP authentication.

At this point the HDMI receiver 104 splits the audio and video signals and routes the audio signal through line 123 to the external audio line 116 (step 258). In the switchbox of FIG. 5, routing the audio from the HDMI receiver to the external audio line 116 requires setting switch S16 to position 1. The system then routes the video signal to the DVI transmitter 106 and DVI OUT port 120 (step 259). This is done by setting switch S3 to position 2 and switch S14 to position 1, to route the video signal to the DVI transmitter 106, and thence to the VIDEO line 126 of the DVI OUT port. The system also provides a connection between the DDC DVI output line 128 and the DVI transmitter to allow periodic HDCP authentication. This is done by setting switch S9 to position 2. The above steps allow the separation of the audio and video signals into DVI video and 2 channel stereo, as shown in FIG. 3

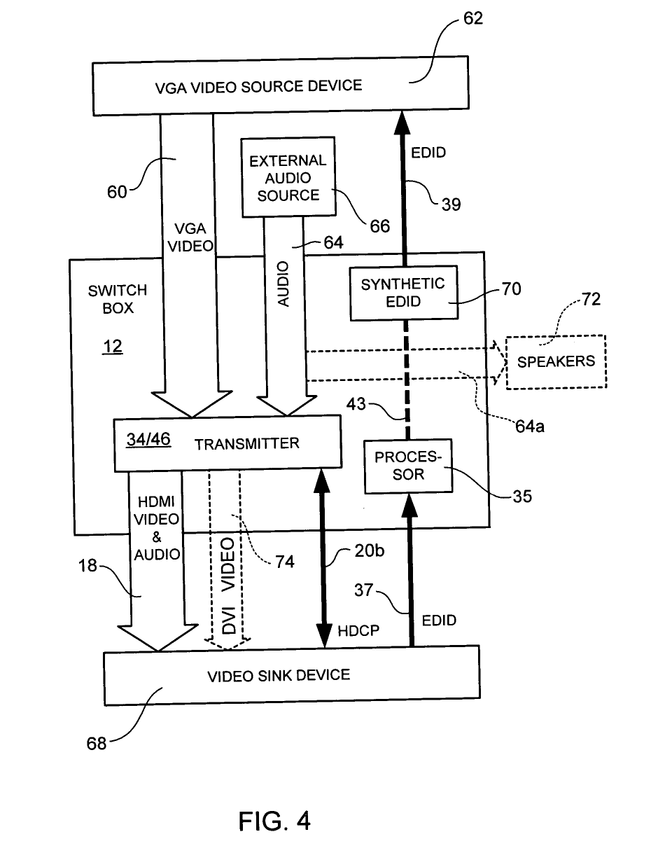

Yet another embodiment of the system and method is illustrated in FIG. 4. In this embodiment, the switchbox 12 is configured to receive a VGA video input signal 60 from a VGA video source device 62, and a separate audio input signal 64 from an external audio device 66, and is connected to a video sink device 68. As in the example of FIG. 1, the video sink device can be (in the case of HDMI output) a single device including a display and speakers. The switchbox 12 includes a transmitter, which will be either an HDMI transmitter 34 or a DVI transmitter 46, depending upon the circumstances. In the case of HDMI output, the transmitter receives the two input signals, combines them, and provides a single AN output signal 18 to the sink device 68. Alternatively, where the output is DVI video, the switchbox routes the audio signal 64a (shown in dashed lines) to an external audio sink device 72 (shown in dashed lines), and the transmitter transmits a DVI video signal 74 (shown in dashed lines) to the video sink device 68, which in this case provides only the video component.

In this situation the sink device 68 most likely defines the base EDID content along with one or more EDID extensions, while the VGA source device 62 probably only expects to read an EDID containing the base EDID content. Consequently, the switchbox reads the EDID of the sink device 68, then creates a custom EDID 70 which is exposed to the VGA source device, this custom EDID being equivalent to the sink device's base EDID, without an EDID extension.

When dynamically updating the EDID contents in the situation of FIG. 4, the switchbox 12 first reads the contents of the EDID of the sink device 68, then reprograms the custom EDID information 70. This involves reprogramming the base 128-byte custom base EDID only. Then the switchbox can enable access to the custom EDID by the video source device 62. As can be seen in FIG. 5, there is no HPD line associated with the VGA input port 121. Consequently, HPD does not take place between the switchbox and the VGA source device 62 in FIG. 4. In this configuration it is anticipated that the user may be required to disconnect and reconnect the VGA source device. Since the VGA interface does not define an HPD control line, the user can manually disconnect and reconnect the source device, to force it to re-read the EDID.

In the case of HDMI output, the switchbox 12 is configured to convert the incoming VGA signal 60 and audio signal 64 into a TMDS signal, which is then sent to the sink device 68. This conversion is performed by the transmitter, as described below. Since the VGA signals bypass the HDMI receiver (104 in FIG. 5), HDCP authentication only takes place between the HDMI or DVI transmitter 34, 46 and the video sink 68, as represented by line 20b in FIG. 4.

The steps involved in providing the custom EDID and transmitting the VGA and external audio input to the sink device in accordance with FIG. 4 are shown in the rightmost column of the flow chart of FIG. 6. Viewing the flow chart of FIG. 6, with reference to the function of FIG. 4 and the structure of FIG. 5, the user first provides input to the switchbox and/or the switchbox automatically detects the characteristics of the connected video sink device in the manner described above, indicating that the source and sink are not both HDMI (step 202), and that the source is VGA (step 246). It is also necessary for the system to know whether the output is to be DVI or not. This question is considered at steps 263 and 269 in FIG. 6. If the output is to be DVI, the processor 102 first connects to the DVI DDC output line 128 (step 260b) in order to read the sink's EDID (step 262). In the switchbox of FIG. 5 this is done by setting switch S8 to position 3, and switch S9 to position 1. If the output is not DVI, the processor first connects to the HDMI DDC output line 122 (step 260a) in order to read the sink's EDID (step 262). In the switchbox of FIG. 5, this is done by setting switch S8 to position 2, switch S7 to position 1, and switch S4 to position 1.

The system then connects the processor 102 to the EDID block 108 (step 264) in order to allow a new synthetic EDID to be prepared by the processor and sent to the EDID block. In the switchbox of FIG. 5 this is done by setting switch S8 to position 1, and switch S6 to position 1. The processor then creates a new EDID correctly describing the composite sink, enables writing of this new EDID (step 266) and writes the new EDID to the EDID block 108 (step 268). In the case of VGA input, the system need only prepare a new base EDID because the VGA source only sends video. Since no audio is sent from the VGA source, no EDID extensions are needed.

With the new EDID programmed, the processor exposes the new custom EDID to the VGA source device (step 270). In the switchbox of FIG. 5 this is done by setting switch S6 to position 3, so that the VGA source device can read the new EDID via DDC line 119.

Once the source device has received the new EDID, the processor then routes the VGA video signal and audio signal to the appropriate destination. The method for doing this depends upon the whether the video output device is a DVI device or not (step 269). Where the video sink device is a DVI device, the system routes only the video signal to the DVI transmitter 106 (step 271a). In the switchbox of FIG. 5, this is done by setting switch S13 and S14 to position 2, so that the VGA signal goes directly to the DVI transmitter. Since DVI only provides video output, the audio and video signals are not combined in this scenario. Instead, only the VGA video signal is routed to the DVI VIDEO line 126 (step 272b), while the external audio is routed through line 123 to the AUDIO OUT line 116. In the switchbox of FIG. 5, this is done by setting switches S15 and S16 to position 2, so that the audio signal is routed through the box with no alteration. The system also sets switch S9 to position 2 in order to allow continued HDCP authentication between the video sink device and the DVI transmitter.

Where the sink device is not a DVI device (as determined at step 269) the external audio and VGA video signals are both routed to the HDMI transmitter 105 (step 271a). This is done by setting switch S15 to position 1, switch S13 to position 1 and switch S12 to position 1. It was noted above that the A/V lines in FIG. 5 can represent multiple conductors for transmitting both audio and video signals. Likewise, while the VGA video line 115 and external audio input line 117 are shown connecting together (following switch S15), this is intended to indicate that, when switch S15 is in position 1, both audio and video signals are sent to a common destination, and does not necessarily indicate that these signals are combined into a single conductor. As noted above, the HDMI transmitter combines the VGA video and external audio signals. The HDMI receiver 104, in addition to having the capability of splitting or combining audio and video signals, is likewise configured to determine when an audio output signal is to be sent through line 123 to the AUDIO OUT 116, or whether a combined audio/video signal is to be sent through switch S3 to one of the transmitters.

The system then routes the combined audio and video signals to the HDMI A/V line 124 (step 272a) to obtain the result shown in FIG. 4. This is done by setting switch S5 to position 1, and S4 to position 2. The setting of switch S4 is required in order to allow continued HDCP authentication between the sink and the HDMI transmitter.

Using a custom EDID content generation system and method as disclosed herein, source devices will automatically see the correct EDID content matching the composite sink device, allowing the source device to automatically adapt the video (and possibly audio) content it is sending to optimally match the capabilities of the composite sink device. Should the user change the configuration of the composite sink device (i.e. change from having audio directed to the 5.1 surround sound system, to having the audio directed to a LUR stereo system), the switch box can dynamically alter the custom EDID contents to reflect the new configuration. In most cases, the switch box can then signal to the source device that the EDID contents have changed. This provides the source device with the ability to re-read the EDID information, so that it can adjust the audio or video data it is generating. This allows the sink device to dynamically adapt to changes in the composite sink device.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. An AV system, comprising:
an AV source device;
a plurality of AV sink devices, each sink device having an EDID; and
a composite EDID content generator, operably disposed between the AV source device and the plurality of AV sink devices, configured to read the EDID of each AV sink device, and to generate a composite EDID representing the combined characteristics of the plurality of AV sink devices.

2. A system in accordance with claim 1, wherein the AV source device is selected from the group consisting of a video source device, an external audio source device, and a combined audio and video source device, and the AV sink devices are selected from the group consisting of a video display, a 2 channel audio system, and an external 5.1 surround-sound audio system.

3. A system in accordance with claim 1, wherein the composite EDID content generator further comprises
an EDID memory module, containing EDID information; and
a processor, interconnected to the EDID memory module and interconnected between an AV source device and a plurality of AV sink devices, each AV sink device having a unique EDID, the processor being configured to generate a combined EDID representing the combined characteristics of the plurality of AV sink devices, and to transmit the combined EDID to the AV source device.

4. A system in accordance with claim 3, wherein the composite EDID content generator further comprises a splitter, configured to separate audio and video portions of a signal from the AV source device and direct the portions to separate audio and video sink devices.

5. A system in accordance with claim 4, wherein the splitter further comprises a receiver, a transmitter, and a plurality of switches, controlled by the processor, the processor manipulating the switches to direct the audio and video portions between the transmitter and receiver and a plurality of output ports.

6. A system in accordance with claim 5, wherein the transmitter is selected from the group consisting of an HDMI transmitter and a DVI transmitter.

7. A system in accordance with claim 1, wherein the composite EDID content generator further comprises a plurality of connection ports, selected from the group consisting of an HDMI input port, an audio output port, an HDMI output port, and a DVI output port.

8. A system in accordance with claim 1, wherein the composite EDID content generator further comprises an audio sink switch configured to designate a selected audio sink device to receive an audio portion of a signal from the AV source device.

9. A system in accordance with claim 8, wherein the audio sink switch is selected from the group consisting of a mechanical switch, and an embedded switch.

10. A system in accordance with claim 1, wherein the composite EDID content generator further comprises a visual display and selection switches whereby a user selects and programs AV source and AV sink settings.

11. A composite EDID content generator, comprising:
an EDID memory module, containing EDID information; and
a processor, interconnected to the EDID memory module and interconnected between an AV source device and a plurality of AV sink devices, each AV sink device having a unique EDID, the processor being configured to generate a combined EDID representing the combined characteristics of the plurality of AV sink devices, and to transmit the combined EDID to the AV source device.

12. A composite EDID content generator in accordance with claim 11, further comprising a signal splitter, configured to direct video and audio portions of a signal from the AV source device to separate video and audio sink devices.

13. A composite EDID content generator in accordance with claim 12, wherein the signal splitter comprises
a receiver, configured to receive the signal from the AV source device, to recognize the type thereof, and to split the signal into audio and video portions; and
a transmitter, configured to receive at least one of the audio and video portions of the AV signal from the receiver, and to transmit the at least one portion to at least one of a plurality of output ports interconnected to the plurality of AV sink devices.

14. A composite EDID content generator in accordance with claim 11, further comprising an audio sink switch, configured to designate a selected audio sink device to receive an audio portion of a signal from the AV source device.

15. A composite EDID content generator in accordance with claim 11, further comprising a visual display and selection switches whereby a user selects and programs AV source and AV sink settings.

16. A method for interconnecting an AV source device and a plurality of AV sink devices, comprising the steps of
reading an EDID of each of the plurality of AV sink devices;
generating a composite EDID representing the combined characteristics of the plurality of AV sink devices; and
exposing the composite EDID to the AV source device.

17. A method in accordance with claim 16, further comprising the step of splitting audio and video portions of a signal from the AV source device between separate audio and video sink devices, respectively.

18. A method in accordance with claim 16, further comprising the step of setting an audio sink switch to designate a selected audio sink device.

19. A method in accordance with claim 16, wherein the step of generating a composite EDID further comprises the steps of:
comparing the EDID of each of the plurality of AV sink devices; and
generating a 128 byte EDID representing the combined characteristics of the plurality of AV sink devices.

20. A method in accordance with claim 19, wherein the step of generating a 128 byte EDID further comprises generating a base EDID with an EDID extension.
